(19) United States
(12) Patent Application Publication
(10) Pub. No.: US 2021/0344962 A1
(43) Pub. Date: Nov. 4, 2021

(54) METHOD AND APPARATUS FOR VIDEO ENCODING AND DECODING WITH SIGNALING OF CODING TYPE OR CODING TREE TYPE

(71) Applicant: InterDigital VC Holdings, Inc., Wilmington, DE (US)

(72) Inventors: Fabrice LeLeannec, Mouazé (FR); Franck Galpin, Thorigne-Fouillard (FR); Philippe Bordes, Laille (FR); Edouard Francois, Bourg des Comptes (FR)

(21) Appl. No.: 17/286,323

(22) PCT Filed: Oct. 24, 2019
(86) PCT No.: PCT/US2019/057817

§ 371 Date: Apr. 16, 2021

(30) Foreign Application Priority Data
Oct. 25, 2018 (EP) 18306388.2
Sep. 20, 2019 (EP) 19306157.9

(51) Int. Cl. H04N 19/70; H04N 19/96; H04N 19/159; H04N 19/186; H04N 19/169; H04N 19/176

(52) U.S. Cl. CPC H04N 19/70; H04N 19/96; H04N 19/176; H04N 19/186; H04N 19/1883; H04N 19/159

(57) ABSTRACT

Implementations for video encoding and decoding involve signaling of at least one syntax data element related to a coding type of at least one region of a picture or of at least one syntax data element related to a coding tree type of at least one region of a picture. For example, at least one syntax data element related to a coding type, such as intra coding or inter coding, of at least one region of a picture is encoded/decoded, a region of a picture is one of a tile, a coding tree unit, a rectangular region of the picture wherein a same coding tree type is used for luma and chroma components; a coding tree type, such as joint or dual, is implicitly or explicitly obtained; and luma and chroma components of the region are encoded/decoded according to the coding type and coding tree type.

### TECHNICAL FIELD

At least one of the present embodiments generally relates to, e.g., a method or an apparatus for video encoding or decoding, and more particularly, to a method or an apparatus with signaling of at least one syntax data element related to a coding type of at least one region of a picture or of at least one syntax data element related to a coding tree type of at least one region of a picture.

### BACKGROUND

The technical field of the one or more implementations is generally related to video compression. At least some embodiments relate to improving compression efficiency compared to existing video compression systems such as HEVC (HEVC refers to High Efficiency Video Coding, also known as H.265 and MPEG-H Part 2 described in “ITU-T H.265 Telecommunication standardization sector of ITU (10/2014), series H: audiovisual and multimedia systems, infrastructure of audiovisual services—coding of moving video, High efficiency video coding, Recommendation ITU-T H.265”), or compared to under development video compression systems such as VVC (Versatile Video Coding, a new standard being developed by JVET, the Joint Video Experts Team).

To achieve high compression efficiency, image and video coding schemes usually employ partitioning of an image, prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy decoding, inverse quantization, inverse transform, and prediction.

With the emergence of new video coding schemes, the partitioning scheme become more complex and allows dual coding tree for luma and chroma to achieve high compression. Besides, it is desirable to allow joint or separated coding tree for both in Intra and non-Intra picture. Therefore, a method for signaling a syntax that allows joint or separated coding tree both in Intra and non-Intra picture in a consistent way is desirable.

### SUMMARY

The purpose of the invention is to overcome at least one of the disadvantages of the prior art. For this purpose, according to a general aspect of at least one embodiment, a method for video encoding is presented, the method comprising encoding at least one syntax data element related to a coding type of at least one region of a picture, wherein the coding type is one of Intra coding or Inter coding, wherein a region of a picture is one of a tile, a coding tree unit CTU, a rectangular region of the picture wherein a same coding tree type is used for luma and chroma components of the rectangular region; obtaining a coding tree type of the at least one region of a picture, the coding tree type being one of joint or dual; and encoding luma and chroma components of the at least one region of a picture according to the coding type and the coding tree type.

According to another general aspect of at least one embodiment, a method for video encoding is presented, comprising encoding at least one syntax data element related to a coding tree type of at least one region of a picture, wherein the coding tree type is one of dual or joint, wherein a region of a picture is one of a tile, a coding tree unit CTU, a rectangular region of the picture wherein a same coding tree type is used for luma and chroma components of the rectangular region; obtaining a coding type of the at least one region of a picture, the coding type being one of Intra coding or Inter coding; and encoding luma and chroma components of the at least one region of a picture according to the coding type and coding tree type. According to another general aspect of at least one embodiment, a method for video decoding is presented, comprising decoding at least one syntax data element related to a coding type of at least one region of a picture, wherein the coding type is one of Intra coding or Inter coding, and wherein a region of a picture is one of a tile, a coding tree unit CTU, a rectangular region of the picture wherein a same coding tree type is used for luma and chroma components of the rectangular region; obtaining a coding tree type of the at least one region of a picture, said coding tree type being one of is one of joint or dual; and decoding luma and chroma components of the at least one region of a picture according to the coding type and coding tree type.

According to another general aspect of at least one embodiment, a method for video decoding is presented, comprising decoding at least one syntax data element related to a coding tree type of at least one region of a picture, wherein the coding tree type is one of dual or joint, and wherein a region of a picture is one of a tile, a coding tree unit CTU, a rectangular region of the picture wherein a same coding tree type is used for luma and chroma components of the rectangular region; obtaining a coding type of the at least one region of a picture, the coding type being one of Intra coding or Inter coding; and decoding luma and chroma components of the at least one region of a picture according to the coding type and the coding tree type. According to another general aspect of at least one embodiment, an apparatus for video encoding is presented comprising means for implementing any one of the embodiments of the encoding methods.

According to another general aspect of at least one embodiment, an apparatus for video decoding is presented comprising means for implementing any one of the embodiments of the decoding methods.

According to another general aspect of at least one embodiment, an apparatus for video encoding is provided, comprising one or more processors, and at least one memory. The one or more processors is configured to implement to any one of the embodiments of the encoding methods.

According to another general aspect of at least one embodiment, an apparatus for video decoding is provided, comprising one or more processors and at least one memory. The one or more processors is configured to implement to any one of the embodiments of the decoding methods.

According to another general aspect of at least one embodiment, obtaining a coding tree type comprises deriving the coding tree type from the coding type, wherein a joint coding tree type indicates that a single coding tree is shared by Luma and Chroma components of the at least one region, a dual coding tree type indicates that separated coding trees between Luma and Chroma components of the at least one region are used, and wherein the coding tree type is dual in case the coding type of the at least one region is Intra coding, wherein the coding tree type is joint in case the coding type of the at least one region is Inter coding.

According to another general aspect of at least one embodiment, obtaining a coding tree type comprising decoding or encoding at least one syntax data element related to a coding tree type of the at least one region of a picture, wherein a joint coding tree type indicates that a single coding tree is shared by Luma and Chroma components of the at least one region, a dual coding tree type indicates that separated coding trees between Luma and Chroma components of the at least one region are used.

According to another general aspect of at least one embodiment, the at least one syntax data element related to a coding type of at least one region of a picture is decoded from or encoded in a header data of the at least one region, or a header data of the first CTU of the at least one region.

According to another general aspect of at least one embodiment, a joint coding tree type indicates that a single coding tree is shared by Luma and Chroma components of the at least one region, a dual coding tree type indicates that separated coding trees between Luma and Chroma components of the at least one region are used.

According to another general aspect of at least one embodiment, a coding type for the at least one region of a picture is derived from the coding tree type, wherein the coding type of the at least one region is Intra coding in case the coding tree type is dual, wherein the coding type of the at least one region is Inter coding in case the coding tree type is joint.

According to another general aspect of at least one embodiment, at least one syntax data element data related to a coding type is encoded or decoded.

According to another general aspect of at least one embodiment, the at least one syntax data element related to a coding tree type of at least one region of a picture is decoded from or encoded in a header data of the at least one region, or a header data of the first CTU of the at least one region.

According to another general aspect of at least one embodiment, the coding tree type is related to a rectangular region of the picture of size RegionTypeSize and the RegionTypeSize is decoded from or encoded in a sequence-level header information, or an image-level header information.

According to another general aspect of at least one embodiment, a non-transitory computer readable medium is presented containing data content generated according to the method or the apparatus of any of the preceding descriptions.

According to another general aspect of at least one embodiment, a signal is provided comprising video data generated according to the method or the apparatus of any of the preceding descriptions.

One or more of the present embodiments also provide a computer readable storage medium having stored thereon instructions for encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1 illustrates an example of Coding Tree Unit (CTU) and Coding Tree (CT) concepts to represent a compressed HEVC picture.

FIG. 2 illustrates an example of division of a Coding Tree Unit into Coding Units, Prediction Units and Transform Units

FIG. 3 illustrates an example of partitioning of a Coding Unit and associated Coding Tree in the Quad-Tree plus Binary-Tree (QTBT) scheme.

FIGS. 4 and 5 illustrate examples of some CU binary or triple tree partitioning.

FIGS. 6 and 7 illustrate various examples of a decoding method according to a general aspect of at least one embodiment.

FIGS. 8 and 9 illustrate various examples of an encoding method according to a general aspect of at least one embodiment.

FIGS. 10, 11 and 12 illustrate various examples of tile arrangements according to various embodiments.

FIGS. 13, 14 and 15 illustrate various examples of assigning a coding type or a coding tree type for a CTU according to various embodiments.

FIG. 17 illustrates a block diagram of an embodiment of video encoder in which various aspects of the embodiments may be implemented.

FIG. 18 illustrates a block diagram of an embodiment of video decoder in which various aspects of the embodiments may be implemented.

FIG. 19 illustrates a block diagram of an example apparatus in which various aspects of the embodiments may be implemented.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of an image. They may be applied to encode/decode a part of image, such as a slice or a tile, a tile group or a whole sequence of images.

Various methods are described above, and each of the methods comprises one or more steps or actions for achieving the described method. Unless a specific order of steps or actions is required for proper operation of the method, the order and/or use of specific steps and/or actions may be modified or combined.

At least some embodiments relate to method for encoding or decoding a video wherein a syntax is signaled, the syntax being representative of the intra/inter or I/P/B type of a picture region to encode/decode in a video sequence, and the type of coding tree used to divide some CTU (coding tree unit) into blocks or coding units (CU).

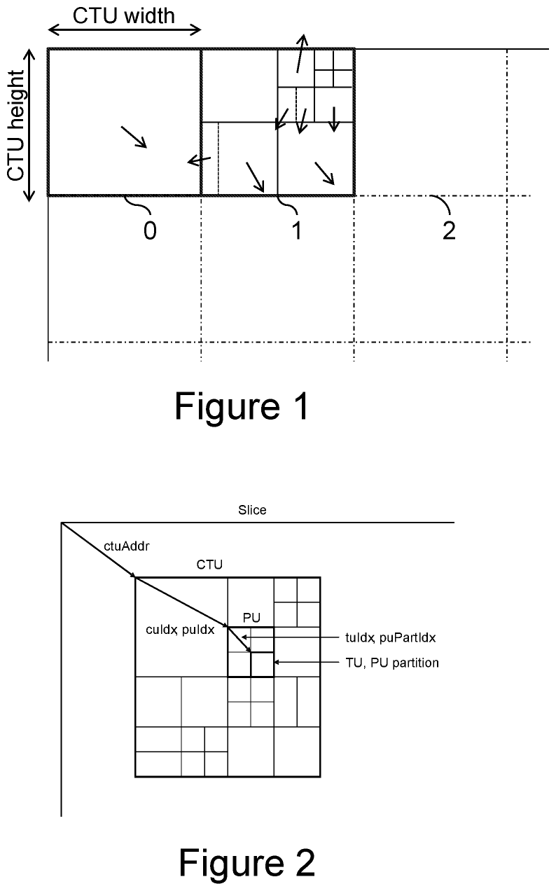

In the HEVC video compression standard, a picture is divided into so-called Coding Tree Units (CTU), which size is typically 64×64, 128×128, or 256×256 pixels. FIG. 1 illustrates an example of Coding Tree Unit (CTU) and Coding Tree (CT) concepts to represent a compressed HEVC picture. Each CTU is represented by a Coding Tree in the compressed domain. This is a quad-tree division of the CTU, where each leaf is called a Coding Unit (CU) as illustrated on FIG. 1. Each CU is then given some Intra or Inter prediction parameters (Prediction Info). To do so, it is spatially partitioned into one or more Prediction Units (PUs), each PU being assigned some prediction information. The Intra or Inter coding mode is assigned on the CU level, as shown on FIG. 2.

New emerging video compression tools include a Coding Tree Unit representation in the compressed domain in order to represent picture data in a more flexible way. The advantage of this more flexible representation of the coding tree is that it provides increased compression efficiency compared to the CU/PU/TU arrangement of the HEVC standard.

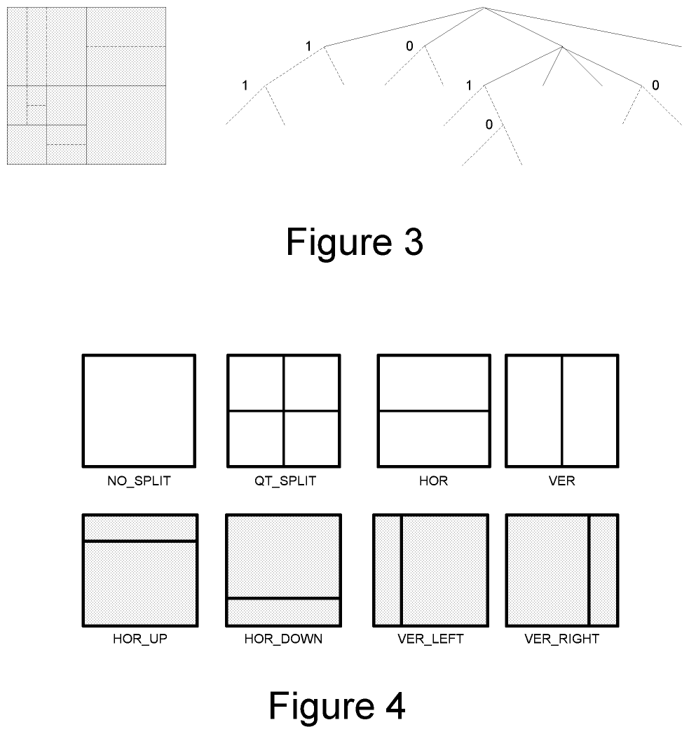

FIG. 3 illustrates an example of partitioning of a Coding Unit and associated Coding Tree in the Quad-Tree plus Binary-Tree (QTBT) scheme. The Quad-Tree plus Binary-Tree (QTBT) coding tool provides this increased flexibility. It consists in a coding tree where coding units can be split both in a quad-tree and in a binary-tree fashion. Such coding tree representation of a Coding Tree Unit is illustrated on FIG. 3.

The splitting of a coding unit is decided on the encoder side through a rate distortion optimization procedure, which consists is determine the QTBT representation of the CTU with minimal rate distortion cost.

In the QTBT technology, a CU has either square or rectangular shape. The size of coding unit is always a power of 2, and typically goes from 4 to 128.

In additional to this variety of rectangular shapes for a coding unit, this new CTU representation has the following different characteristics compared to HEVC.

The QTBT decomposition of a CTU is made of two stages: first the CTU is split in a quad-tree fashion, then each quad-tree leaf can be further divided in a binary fashion. This is illustrated on the right of FIG. 3 where solid lines represent the quad-tree decomposition phase and dashed lines represent the binary decomposition that is spatially embedded in the quad-tree leaves.

In intra slices, the Luma and Chroma block partitioning structure is separated, and decided independently.

No more CU partitioning into predictions units or transform unit is employed. In other words, each Coding Unit is systematically made of a single prediction unit (2N×2N prediction unit partition type) and single transform unit (no division into a transform tree).

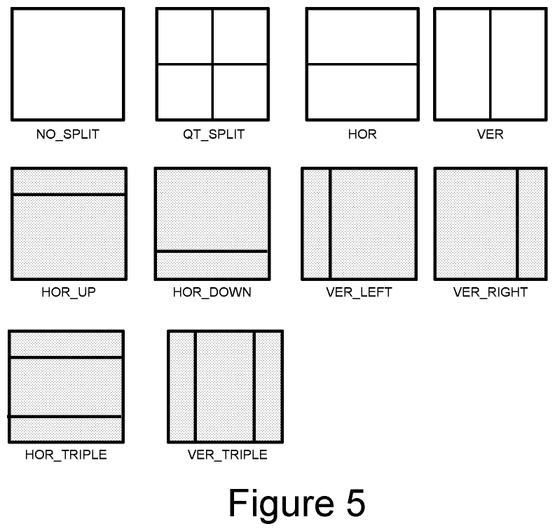

Finally, some other CU binary or triple tree partitioning may also be employed in the representation of the CTU's coding tree. FIGS. 4 and 5 illustrate examples of some CU binary or triple tree partitioning. In the additional asymmetric binary and tree split modes, a rectangular coding unit with size (w, h) (width and height) that would be split through one of the asymmetric binary splitting modes, for example HOR_UP (horizontal-up), would lead to 2 sub-coding units with respective rectangular sizes

$$( w , \frac{h}{4} ) and ( w , \frac{3 h}{4} ) .$$

In addition, the so-called triple tree partitioning of a CU may be used, leading to the set of possible partitions given in FIG. 5. Triple tree consists in splitting a CU into tree sub-CU with size (¼,½,¼) relative to the parent CU, in the considered orientation.

A significant coding efficient improvement is brought using the new topologies described above. In particular, a significantly gain is obtained in chroma, thanks to the separation of the coding tree, between the luma component on one size, and the two chroma components on the other side.

However, it is desired that the management of the separated or dual coding tree between luma and chroma components is specified in a consistent way in the WC video compression currently being standardized. This consistency includes the possibility to employ joint or separated coding tree both in Intra and non-Intra picture. A method for signaling a syntax that allows joint or separated coding tree both in Intra and non-Intra picture is therefore desirable. At least one embodiment of the present principles addresses the issue of providing a consistent syntax design to signal the intra/inter or I/P/B type of a picture region to encode/decode in a video sequence, and the type of coding tree used to divide some CTU (coding tree unit) into blocks or coding units (CU). According to a particular feature of the at least one embodiment, the type of a coding tree is determined among two types: separated between luma and chroma components or shared between luma and chroma components. By consistent, one means that the signaling of the intra/inter type and shared/separated is the same in every picture of the video sequence to be compressed or decompressed.

At least one embodiment of the present disclosure comprises determining regions in the picture that have attached a same coding type and a same coding tree type. An example of region coding type is intra or inter, where intra means the region is intra coded, i.e. all coding units contained in the region are coded in intra mode. The region is said to be inter or non-intra otherwise, i.e. CUs in that region may be coded in inter or intra mode. An example of region coding tree type is dual or joint. A coding tree of type dual corresponds to separated coding trees between Luma and Chroma components. A coding tree of type joint corresponds to a shared coding tree between Luma and Chroma components. An example of a region is a tile, a tile-group, a CTU or a new region of determined size that have a same coding type or/and coding tree type.

In section 1, 2 embodiments are disclosed for a decoding method corresponding to the syntax element decoded at a higher level among coding type and coding tree type.

In section 2, 2 embodiments are disclosed for an encoding method corresponding to the syntax element encoded at a higher level among coding type and coding tree type.

Sections 3 to 10 disclose various embodiments of the encoding or decoding method according to combination of region level (tile, CTU, rectangular region) and the syntax element (coding type and coding tree type).

### 1. Embodiments Fora Decoding Method

Two embodiments are disclosed for a decoding method corresponding to the syntax element signaled at a higher level, the first of the embodiment corresponding to coding type decoded at a higher level before to coding tree type and the second of the embodiment corresponding to coding tree type decoded at a higher level or before to coding type.

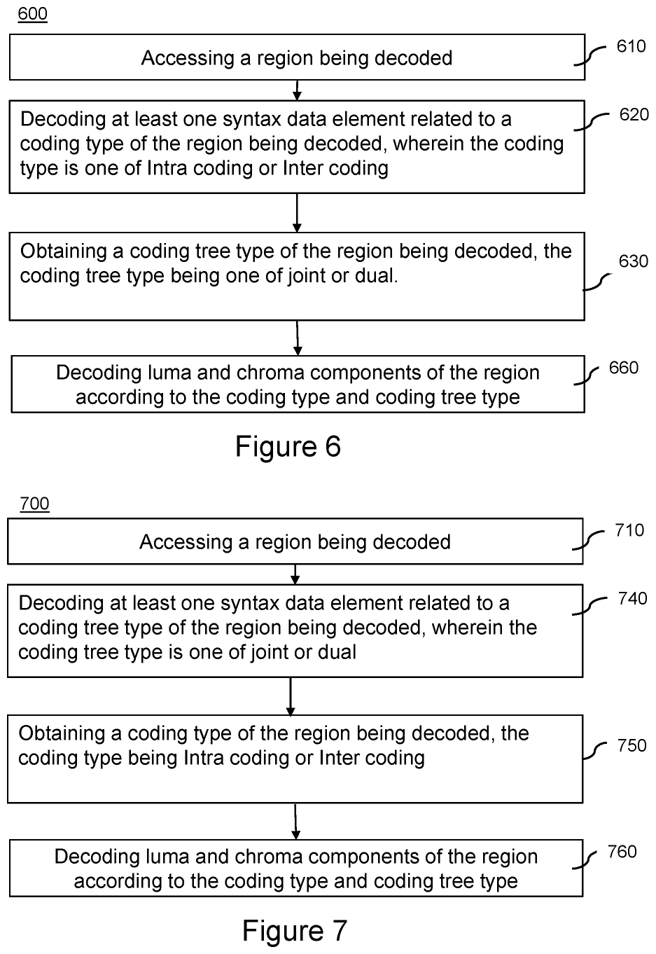

FIG. 6 illustrates a decoding method according to a general aspect of the first embodiment. According to at least one aspect of the present disclosure, a decoding method 600 is disclosed. The decoding method 600 comprises in a step 610 accessing at least one region of a picture to be decoded. The region of a picture is one of a tile, a coding tree unit CTU, a rectangular region of the picture, for example of size RegionTypeSize, wherein a same coding tree type is used for luma and chroma components of the rectangular region. An example of a region according to the present principles is disclosed in section 7. Then, in a step 620, at least one syntax data element is decoded. In this embodiment the syntax data element relates to a coding type of the at least one region of a picture, wherein the coding type is one of Intra coding or Inter coding. Advantageously, the method then comprises, in a step 630, obtaining a coding tree type of the at least one region of a picture, the coding tree type being one of joint or dual. A joint coding tree type indicates that a single coding tree is shared by Luma and Chroma components of the at least one region, while a dual coding tree type indicates that separated coding trees between Luma and Chroma components of the at least one region are used. As explained hereafter, the coding tree type is either implicitly derived from the coding type or explicitly decoded from another syntax element. Finally, in step 660, luma and chroma components of the at least one region of a picture are decoded according to the coding type and coding tree type.

Advantageously, the disclosed method allows more flexibility in the choice of the coding type/coding tree type of the CTUs of a region while reducing the complexity of implementation at a decoder.

According to different variants, for instance discussed in section 3, a coding tree type is implicitly or explicitly obtained. According to a first variant, obtaining a coding tree type comprises deriving the coding tree type for the at least one region of a picture from the coding type, wherein the coding tree type is dual in case the coding type of the at least one region is Intra coding and wherein the coding tree type is joint in case the coding type of the at least one region is Inter coding. According to a second variant, obtaining a coding tree type comprises decoding at least one syntax data element related to a coding tree type of the at least one region of a picture.

According to a particular feature, the at least one syntax data element related to a coding type and/or coding tree type of at least one region of a picture is decoded from a header data of the at least one region (being a tile, a tile-group or a rectangular region defined for sharing coding/coding tree), or a header data of the first CTU of the at least one region.

According to a particular feature, the RegionTypeSize is decoded from a sequence-level header information, or an image-level header information.

FIG. 7 illustrates a decoding method according to a general aspect of the second embodiment. According to at least one aspect of the present disclosure, a decoding method 700 is disclosed. The decoding method 700 comprises in a step 710, accessing at least one region of a picture to be decoded. Then, in a step 740, at least one syntax data element is decoded. In this embodiment the syntax data element relates to a coding tree type of the at least one region of a picture. Advantageously, the method then comprises, in a step 750, obtaining a coding type of at least one region of a picture, wherein the coding type is one of Intra coding or Inter coding. Finally in a step 760, luma and chroma components of the at least one region of a picture are decoded according to the coding type and coding tree type.

As previously, the disclosed method advantageously allows more flexibility in the choice of the coding type/coding tree type of the CTUs of a region while reducing the complexity of implementation at a decoder.

Respectfully, according to different variants, for instance discussed in section 4, a coding type is implicitly or explicit obtained. According to a first variant, obtaining a coding type comprises deriving the coding type for the at least one region of a picture from the coding tree type, wherein the coding type of the at least one region is Intra coding in case the coding tree type is dual and wherein the coding type of the at least one region is Inter coding in case the coding tree type is joint. According to a second variant, obtaining a coding type comprises decoding at least one syntax data element related to a coding type of the at least one region of a picture. According to a particular feature, the at least one syntax data element related to a coding type and/or coding tree type of at least one region of a picture is decoded from a header data of the at least one region (being a tile, a tile-group or a rectangular region defined for sharing coding/coding tree), or a header data of the first CTU of the at least one region.

According to a particular feature, the RegionTypeSize is decoded from a sequence-level header information, or an image-level header information.

### 2. Embodiments for an Encoding Method

Two embodiments are disclosed for a encoding method corresponding to the syntax element signaled at a higher level, the first of the embodiment corresponding to coding type encoded at a higher level or before to coding tree type and the second of the embodiment corresponding to coding tree type encoded at a higher level or before to coding type.

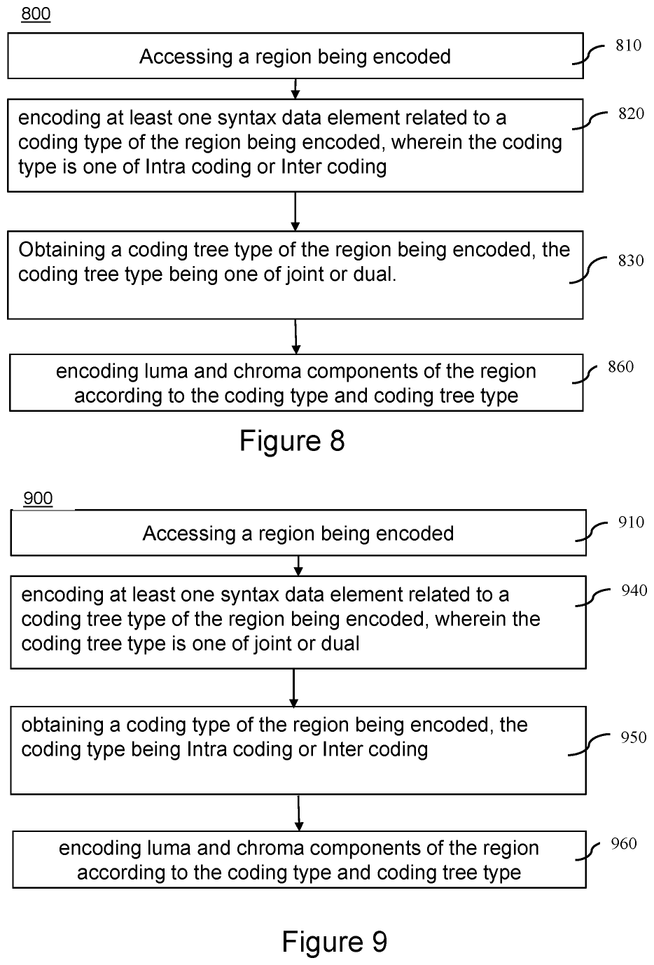

FIG. 8 illustrates an encoding method according to a general aspect of the first embodiment. According to at least one aspect of the present disclosure, an encoding method 800 is disclosed. The encoding method 800 comprises, in a step 810, accessing at least one region of a picture to be encoded and associated encoding parameters such as coding type and coding tree type. The region of a picture is one of a tile, a coding tree unit CTU, a rectangular region of the picture, for example of size RegionTypeSize, wherein a same coding tree type is used for luma and chroma components of the rectangular region. An example of a region according to the present principles is disclosed in section 8. In a step, 820 at least one syntax data element related to a coding type of at least one region of a picture is encoded first. The coding type is one of Intra coding or Inter coding. Then, according to various embodiments; in a step 820, a coding tree type of the at least one region of a picture is obtained, the coding tree type being one of joint or dual. Again, a joint coding tree type indicates that a single coding tree is shared by Luma and Chroma components of the at least one region, while a dual coding tree type indicates that separated coding trees between Luma and Chroma components of the at least one region are used. Finally, in a step 860, the luma and chroma components of the at least one region of a picture are encoded according to the coding type and coding tree type.

Advantageously, the disclosed method allows more flexibility in the choice of the coding type/coding tree type of the CTUs of a region while reducing the complexity of implementation at the coder.

According to a first variant, the coding tree type for the at least one region of a picture is not encoded, and is derived on the decoder side from the coding type, wherein the coding tree type is dual in case the coding type of the at least one region is Intra coding and wherein the coding tree type is joint in case the coding type of the at least one region is Inter coding. According to a second variant, explicitly coding a coding tree type comprises encoding at least one syntax data element related to a coding tree type of the at least one region of a picture. According to a particular feature, the at least one syntax data element related to a coding type and/or coding tree type of at least one region of a picture is encoded in a header data of the at least one region (being a tile, a tile-group or a rectangular region defined for sharing coding/coding tree), or a header data of the first CTU of the at least one region.

According to a particular feature, the RegionTypeSize is encoded in a sequence-level header information, or in an image-level header information.

FIG. 9 illustrates an encoding method according to a general aspect of the second embodiment. According to at least one aspect of the present disclosure, an encoding method 900 is disclosed. The encoding method 900 comprises in a step 910 that comprises accessing at least one region of a picture to be encoded and associated encoding parameters such as coding type and coding tree type. Then, in a step 940, at least one syntax data element related to a coding tree type of at least one region of a picture, the coding tree type being one of joint or dual. In a step 950, a coding type of the at least one region of a picture is obtained, the coding type is one of Intra coding or Inter coding. Finally, in a step 960, luma and chroma components of the at least one region of a picture are encoded according to the coding type and coding tree type.

Advantageously, the disclosed method allows more flexibility in the choice of the coding type/coding tree type of the CTUs of a region while reducing the complexity of implementation at the coder.

According to a first variant, coding type for the at least one region of a picture it not encoded and is derived on the decoder side from the coding tree type, wherein the coding type of the at least one region is Intra coding in case the coding tree type is dual and wherein the coding type of the at least one region is Inter coding in case the coding tree type is joint. According to a second variant, explicitly coding a coding tree type comprises encoding at least one syntax data element related to a coding type of the at least one region of a picture.

According to a particular feature, the at least one syntax data element related to a coding type and/or coding tree type of at least one region of a picture is encoded in a header data of the at least one region (being a tile, a tile-group or a rectangular region defined for sharing coding/coding tree), or a header data of the first CTU of the at least one region.

According to a particular feature, the RegionTypeSize is encoded in a sequence-level header information, or in an image-level header information.

The following sections describes various embodiments of the generic alternative method for encoding or decoding.

### 3 Variant Embodiment 1: Tile-Level Indication of the Intra/P/B Coding Type

According to a variant of the first embodiment, variant embodiment 1, the picture is divided into tile(s), and the tile is being assigned an intra/inter coding type, i.e. intra or inter. This coding type may be signaled as header data of the considered tile. In another variant, the coding type is signaled in the tile-group header. When signaled as header data of the considered tile, the header of the tile may take different forms. According to a first form, the coding type is coded in the header of the first CTU contained in the considered tile. According to a second form, a tile-header syntax element set is defined. It contains a field corresponding to the coding type intra/inter of the considered tile.

Moreover, each tile is divided into Coding Tree Units (CTUs), typically of size 128×128. If the tile is of intra type, then all CTUs in it are represented in the compressed domain through separated coding trees between Luma and Chroma components. If the tile is of inter type, then all CTUs in the tile are coded/decoded with a single coding tree, shared by the Luma and Chroma components.

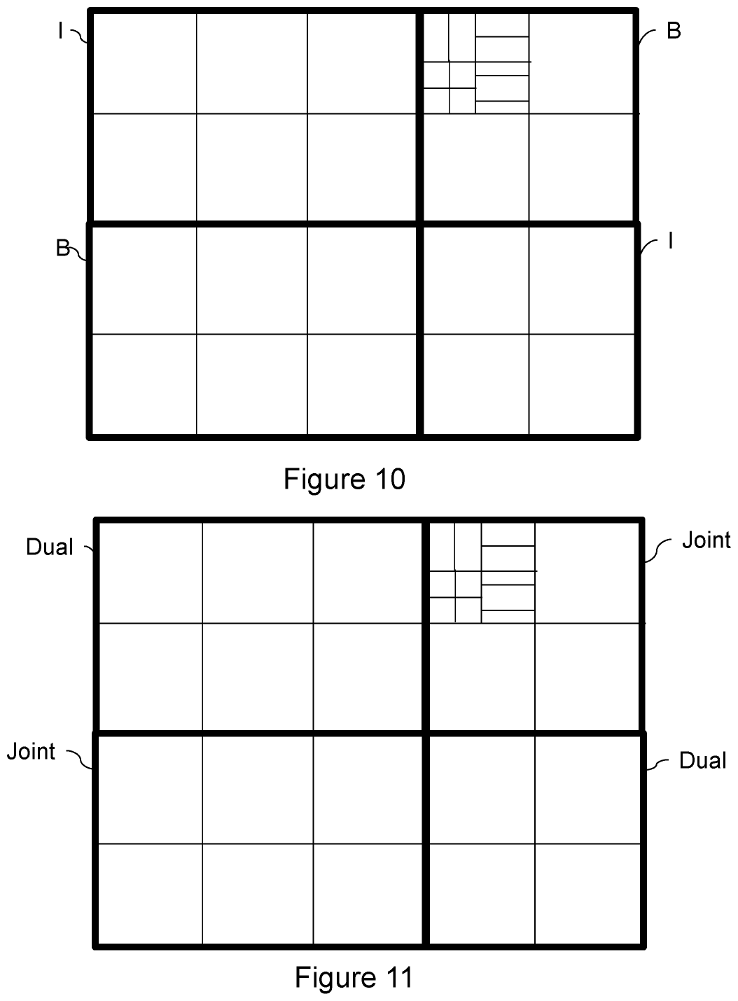

FIG. 10 illustrates a variant of the first embodiment. The illustrated picture of FIG. 10 is divided into 4 tiles (bold lines). According to a particular example, the coding type of each type (I for intra and B for Inter where coding units may be coded with bi-prediction) is illustrated for the 4 tiles. The tile partitioning into CTU is also shown, as well as the coding tree representation of a CTU one of the two B tiles. As a result of this variant of the first embodiment, each picture employs the same type of high-level syntax to indicate the type of coded blocks in the considered picture. This makes the design consistent among all pictures. Note that in this approach, no more slice is considered, and no slice type (Intra, B, P) is present in the design of the high-level syntax as was the case in HEVC.

According to another variant, an additional tile-level syntax element indicates, if the tile is intra, if the CTUs in the tile are coded with a joint luma/chroma coding tree or separate luma/chroma coding trees. This syntax element thus takes the form of a flag, which, for instance, is equal to true if the coding tree of the CTUs in the tile are separated between Luma and Chroma and is equal to false otherwise.

According to a further variant, in all CTUs in the tile a CTU-level flag indicates if a joint or separated coding tree is used to code the CTU. In that case, each CTU of each picture contains a flag that indicates if a joint or separated coding tree is used to code the CTU.

### 4 Variant Embodiment 2: Tile-Level Indication of the Joint/Separated Coding Tree

According to a variant of the second embodiment, variant embodiment 2, presented in this section, the type of coding tree is signaled at a higher level than the intra/inter or I/P/B coding type of a picture region. Indeed, according to a variant of the second embodiment, a tile-level flag indicates if the coding tree of each CTU in the tile is a joint coding tree between luma and chroma components or is a separated coding tree.

FIG. 11 illustrates a variant of the second embodiment. In this embodiment, if the tile-level coding tree type is dual (i.e. separated) between Luma and Chroma, then all CTUs contained in the considered tile are inferred in intra mode. If the tile-level coding tree type is joint (i.e. not separated) between Luma and Chroma, then all CTUs contained in the considered tile are coded in inter or intra mode. In that case, the CU-level syntax indicates the intra or inter CU coding mode, as currently done in VVC draft standard version.

In this embodiment, according to another variant, each CTU is assigned an intra/inter or I/P/B coding mode. Therefore, some CTU-level syntax element indicates the CTU coding mode. The advantage of this variant is that it introduces some more flexibility in the design of the codec, hence may lead to higher coding efficiency. Indeed, in this mode, separated of joint luma/chroma coding tree can be used in both CTU coding modes.

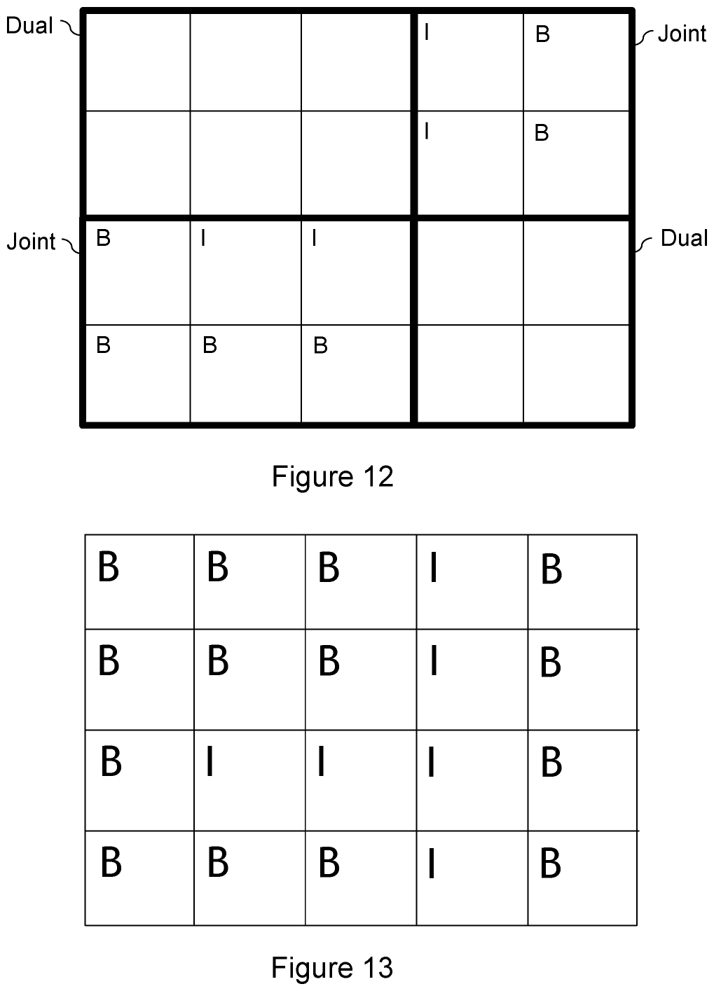

According to yet another variant, the CTU-level intra/inter or I/P/B coding mode is only signaled if the joint coding tree type is signaled in the tile header. This last variant is illustrated on FIG. 12. For the top right and bottom left tiles of type joint, the coding mode Intra/Inter is signaled, while for the top left and bottom right tiles of type Dual, the mode Intra is inferred for the CTUs. In another variant, the joint/separated coding tree type is signaled in the tile-group header rather than on the tile level. Then the same variants as previously described in this section apply on the tile-group header level.

### 5 Variant Embodiment 2: Slice-Level Indication of the Joint/Separated Coding Tree

In this variant of the second embodiment, the joint/dual coding tree type may be signaled on the sequence parameter set (SPS) level. Additionally, it may be overridden on the slice level, through a slice header syntax element which may signal the overriding of the SPS level coding tree type. If overridden, then the joint or dual coding tree type may be signaled in the slice header.

In a variant, if the SPS level coding tree is signaled as overridden in the slice, then the coding tree type of the considered slice may be inferred as the coding tree type different from the SPS-level signaled coding tree type.

In a variant, a single flag may be coded in the slice header may be signaled to indicate if the coding tree used in the corresponding slice is the same as that of the SPS level signaled one or not.

### 6 Variant Embodiment 2: PPS-Level Indication of the Joint/Separated Coding Tree

In this variant of the second embodiment, the type of coding tree is signaled in the slice header. In this embodiment, the joint/dual coding tree type may be signaled on the sequence parameter set (SPS) level. Additionally, it may be overridden on the picture parameter set (PPS) level, through a PPS syntax element which may signal the overriding of the SPS level coding tree type. If overridden, then the joint or dual coding tree type may be signaled in the PPS.

In a variant, if the SPS level coding tree is signaled as overridden in the PPS, then the coding tree type attached to the considered PPS may be inferred as the coding tree type different from the SPS-level signaled coding tree type.

In a variant, a single flag may be coded in the PPS may be signaled to indicate if the coding tree attached to the considered PPS is the same as that of the SPS level signaled one or not.

### 7 Variant Embodiment 3: CTU-Level Intra/Inter of I/P/B Coding Mode Signaling

According to a variant of the second embodiment, variant embodiment 3, the type of coding tree and high-level intra/inter coding mode is no more signaled on the tile level, but on the CTU-level. The variant embodiment 3 basically comprises signaling the intra/inter or I/P/B coding mode, as well as the coding tree type, on the CTU level. These parameters are no more coded at the tile level as in previous embodiment, but on the CTU level.

FIG. 13 illustrates an example of an embodiment assigning a coding mode intra/inter or I/P/B to each CTU, and signaling it on the CTU level. In this variant embodiment 3, according to a particular feature, the CTU-level intra/inter signaling flag is context-based arithmetic coded. To do so, if the CTU-level coding mode comprises an inter/intra coding mode, then a flag is coded. A CABAC context based on the flag value of the left and top neighboring CTU, when available, is employed. Depending on the flag values in these neighboring CTUs, 3 different CABAC contexts can be used to encode current CTU's intra/inter coding mode flag.

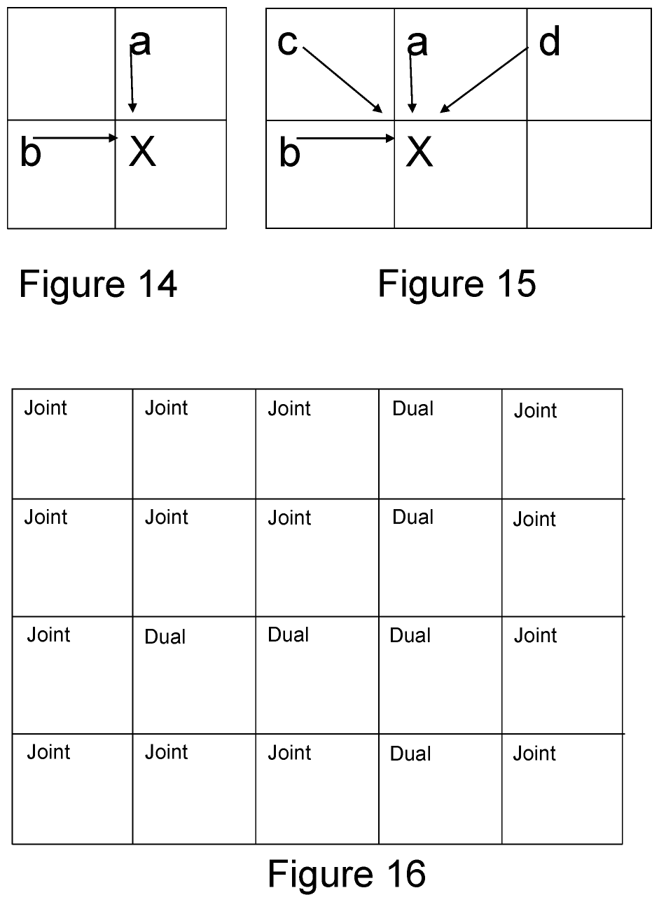

The context index used for current CTU is thus compute as: ctxIdx=(a? 1:0)+(b? 1:0) where a and b represent the flags of the left and top CTUs. FIG. 14 illustrates such context coding of current CTU's intra/inter coding mode flag x.

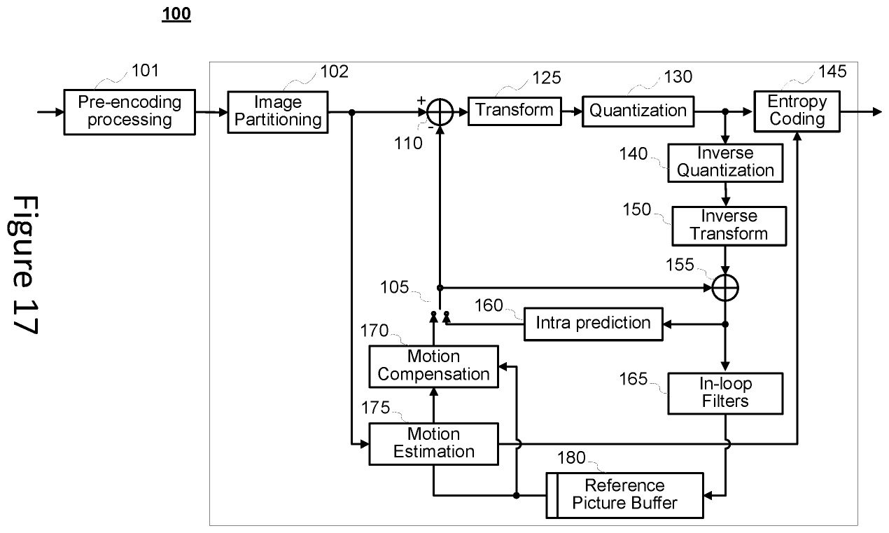

FIG. 15 illustrates another example of such context coding of current CTU's intra/inter coding mode flag x with a richer set of contexts used to encode the CTU-level intra/inter coding mode flag x.

In the variant embodiment 3, if the CTU is of intra coding type, then a separated coding tree is used to produce a block-based partitioning of the considered CTU. In that case, the coding tree is shared between luma and chroma down to the size 64×64 as in the VVC draft version, and a quad-tree division of the CTU is performed down to that block size. If the CTU is of non-intra or inter type, then a single coding tree is commonly used to encode both luma and chroma components of the considered CTU.

According to yet another variant, if the CTU is of intra type, then an additional CTU-level flag is coded if a joint coding tree or a separate tree is used in the block partitioning of luma and chroma components.

According to yet another variant, whatever CTU-level coding mode, an additional CTU-level flag is coded if a joint coding tree or a separate tree is used in the block partitioning of luma and chroma components.

### 8 Variant Embodiment 4: Signaling of the CTU-Level Coding Tree Type Before Signaling or Deriving the CTU-Level Intra/Inter Mode

According to a variant of a fourth embodiment, variant embodiment 4, at the CTU level, a flag is coded at the CTU level but it has a different semantic compared to the variant embodiment 3. In variant embodiment 4, the CTU-level flag indicates if the CTUs contained in the considered tile employ separate or common coding trees between luma and chroma components. FIG. 16 illustrates an example of a signaling at the CTU-level of the coding tree type, being joint or dual. Then, as a matter of fact, 3 different variants existing inside this embodiment for deriving the CTU-level intra/inter mode:

Firstly, if the CTU use separate trees, intra coding type is inferred for the considered CTU. Additionally, if the CTU uses the same coding tree for luma and chroma, then inter coding is inferred for current CTU.

Secondly, if the CTU use separate trees, intra coding type is inferred for the considered CTU. Additionally, if the CTU uses the same coding tree for luma and chroma, then a CTU coding mode flag is signed to indicate intra or inter coding.

Thirdly, whatever the use of joint or separate luma/chroma coding trees, a CTU-level flag is coded and indicates the intra or inter coding mode in the concerned CTU.

### 9 Variant Embodiment 5: New Concept of Region Type Size

According to a variant of a fourth embodiment, variant embodiment 5, the CTU coding mode and type of coding tree is signaled on the CTU-level, as in embodiment 3.

Additionally, a new concept of region type size is introduced. The region type size is the size of a rectangular picture region in which a single coding tree type is employed in the luma/chroma block partitioning. The region tree type size is lower or equal to the CTU size. In this following it is noted regionTypeSize.

Generally speaking, the region type size is equal to the CTU size. In that case, one of the embodiments 1 or 3 is used to signal the intra/inter coding type of a region and the use of separated or joint luma/chroma coding tree in that picture region. Here by region one means a tile or a CTU, depending on the embodiment between 1 or 3 being used.

However, in some configurations, it may be lower. For instance, the CTU size may be 256×256 and the region type size may be equal to 128×128.

In this case, a variant of embodiment 5, the qt_split_flag, which indicates if the CTU is split in a quad-tree fashion, may be coded on the CTU level before coding the information related to the CTU-level intra/inter mode or CTU-level coding tree type. This approach can be used for optimized coding efficiency.
In this case, if the qt_split_flag is false, then the intra/inter flag is inferred to be equal to inter for the whole CTU. Indeed, it is stated in a VVC draft that in an intra picture or slice, a CTU is systematically divided in a quad-tree fashion until the region type size. Therefore, if a binary or ternary split is used in a CU larger than the region type size, then the concerned CTU is necessarily of non-intra mode. Moreover, in that case, the luma and chroma components may use the same coding trees.
Otherwise, if the qt_split_flag is true, then CTU is split into four CUs.
   For each resulting CU, the above process is applied in a recursive way on each CU issued from the quad-tree partitioning. When a CU of the same size as the regionTypeSize is reached then the intra/inter type flag is signaled before any split information in that CU.
   According to a variant, on the regionTypeSize level, if the intra/inter type fag indicates the intra type for current region, then the Luma and Chroma coding trees are separated. Moreover, if the intra-inter type flag indicates the inter type, then the same coding tree is used for all Luma and Chroma components.
   According to another variant, on the regionTypeSize level, if the inter mode is signaled by the intra/inter flag, then a joint coding tree is used between Luma and Chroma components. However, if the intra mode is signaled, a further flag indicates if the Luma and Chroma components use a joint coding tree or separated coding trees.
Alternatively, in another variant, a flag is signaled on the CTU level whatever the intra/inter type of the region (tile/picture/ctu) that contains the CTU, to signal if the coding tree in the CTU is shared or separated between the luma and chroma components.
In a further variant, if the CTU is of intra type, the separated/joint coding tree type is coded on the VPDU (64×64) level. Indeed, since the CTU is always split in a quad-tree fashion in luma and chroma down to the 64×64 luma block size, some added flexibility can be added in the splitting of the current CTU, leading to potentially higher coding efficiency.

### 10 Variant Embodiment 6: New Concept of Region Tree Type Size

According to a variant of a fourth embodiment, the regionTypeSize is used as above, but a joint/separate coding tree information is coded before the intra/inter mode information. This takes the following form.

Generally speaking, the region type size is equal to the CTU size. In that case, one of the embodiments 2 or 4 is used to signal the coding tree type of a region and the use of intra/inter mode in that picture region. Here by region one means a tile or a CTU, depending on the embodiment between 2 or 4 being used.

However, in some configurations, the region type size may be lower. For instance, the CTU size may be 256×256 and the region type size may be equal to 128×128.

In this case, in a variant of the embodiment 6, the qt_split_flag, which indicates if the CTU is split in a quad-tree fashion, may be coded on the CTU level before coding the information related to the CTU-level coding tree type or CTU-level intra/inter mode. This approach can be used for optimized coding efficiency.
In this case, if the qt_split_flag is false, then the coding tree type is inferred to be equal to be joint. Indeed, it is stated in a WC draft that in an intra picture or slice, a CTU is systematically divided in a quad-tree fashion until the region type size. Therefore, if a binary, ternary split or no-split partitioning mode is used in a CU larger than the region tree size, then the concerned CTU is necessarily of non-intra mode, and a single coding tree is shared among Luma and Chroma components. So in this variant embodiment, in the considered situation, it is inferred that the Luma and Chroma components share the same coding tree.
Otherwise, if the qt_split_flag is true, then the CTU is split into four CUs.
   For each resulting CU, the above process is applied in a recursive way on each CU issued from the quad-tree partitioning. When a CU of the same size as the regionTypeSize is reached then the separate/shared coding tree type flag is signaled before any split information in that CU.
   According to a variant, on the regionTypeSize level, if the Luma/Chroma coding trees are separated, then the intra type for current region is inferred. Moreover, if the separated/shared tree type flag indicates the shared type, then the inter mode is inferred for the considered region.
   According to another variant, on the regionTypeSize level, if the separate tree mode is signaled by the shared/separate flag, then the intra mode is inferred for the considered region. However, if the shared mode is signaled, a further flag indicates if the region is fully coded in intra or not.
Alternatively, in another variant, a flag is signaled on the CTU level whatever the shared/separate type of the region (tile/picture/ctu) that contains the CTU, to signal if the coding mode in the CTU is full intra or not.
In a further variant, if coding tree is of shared type, the intra/inter region type is coded on the VPDU (64×64) level. Indeed, since the CTU is always split in a quad-tree fashion in luma and chroma down to the 64×64 luma block size, some added flexibility can be added in the splitting of the current CTU, leading to potentially higher coding efficiency.

### 11 Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 17, 18 and 19 below provide some embodiments, but other embodiments are contemplated and the discussion of FIGS. 17, 18 and 19 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side. Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the partitioning module (102, 235), of a video encoder 100 and decoder 200 as shown in FIG. 16 and FIG. 17. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, regionTypeSize. The specific values are for example purposes and the aspects described are not limited to these specific values.

FIG. 17 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

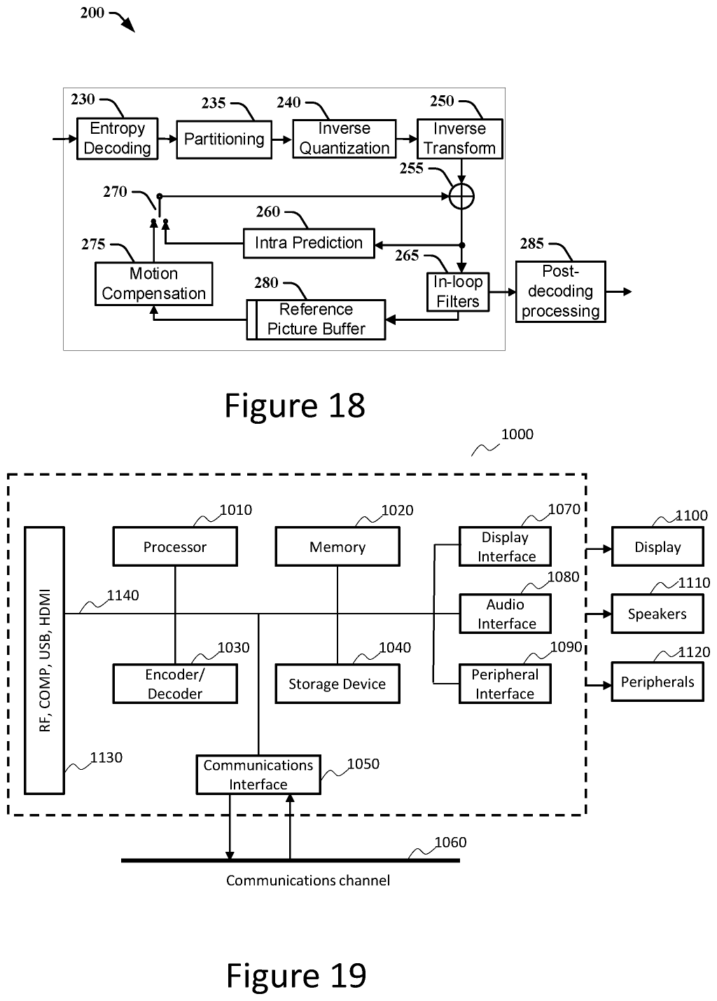

FIG. 18 illustrates a block diagram of a video decoder 200. In the decoder 200, a bitstream is decoded by the decoder elements as described below. Video decoder 200 generally performs a decoding pass reciprocal to the encoding pass as described in FIG. 17. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280). The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 19 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 10, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decoding at least one syntax data element related to a coding type or a coding tree type of at least one region of a picture and decoding luma and chroma components of the at least one region of a picture according to the coding type and coding tree type, wherein a region of a picture is one of a tile, a coding tree unit CTU, a rectangular region of the picture of size RegionTypeSize.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art. Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, encoding at least one syntax data element related to a coding type or a coding tree type of at least one region of a picture and encoding luma and chroma components of the at least one region of a picture according to the coding type and coding tree type, wherein a region of a picture is one of a tile, a coding tree unit CTU, a rectangular region of the picture of size RegionTypeSize.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, for example, the coding type comprising Intra or Inter and the coding tree type comprising joint or dual are descriptive terms. As such, they do not preclude the use of other syntax element names. For instance non-Intra can be used instead of Inter, separated instead of dual.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for region coding as coding type or coding tree type. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination. Further, embodiments can include one or more of the following features, devices, or aspects, alone or in any combination, across various claim categories and types:
Modifying the coding type/coding tree type applied in the decoder and/or encoder.
Modifying the region level to which coding type/coding tree type applies in the decoder and/or encoder.
Enabling several advanced coding/coding tree prediction methods in the decoder and/or encoder.
Inserting in the signaling, syntax elements that enable the decoder to identify coding type/coding tree type for luma and chroma components at a region level.
Selecting, based on these syntax elements, the coding/coding tree prediction method to apply at the decoder.
Decoding/encoding luma and chroma according to any of the embodiments discussed.
A bitstream or signal that includes one or more of the described syntax elements, or variations thereof.
Inserting in the signaling syntax elements at the header data of the region (being a tile, a tile-group or a rectangular region defined for sharing coding/coding tree), or at header data of the first CTU of the region.
Decoding/encoding a RegionTypeSize from a sequence-level header information, or an image-level header information.
Creating and/or transmitting and/or receiving and/or decoding a bitstream or signal that includes one or more of the described syntax elements, or variations thereof.
A TV, set-top box, cell phone, tablet, or other electronic device that performs encoding/decoding of a region of a picture according to any of the embodiments described.
A TV, set-top box, cell phone, tablet, or other electronic device that performs encoding/decoding of a region of a picture according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image and encoded syntax element according to any of the embodiments described.
A TV, set-top box, cell phone, tablet, or other electronic device that receives (e.g. using an antenna) a signal over the air that includes an encoded image and encoded syntax element according to any of the embodiments described.

1-15. (canceled)

16. A method, comprising:
decoding at least one syntax data element related to a coding tree type of at least one region of a picture, wherein the coding tree type is one of dual or joint, a dual coding tree type indicating two separate coding syntax structure for luma and chroma components, a joint coding tree type indicating a coding syntax structure commonly used for luma and chroma components, and wherein a region of a picture is one of a tile, a coding tree unit CTU, a rectangular region of the picture wherein a same coding tree type is used for luma and chroma components of the rectangular region;
obtaining a coding type of the at least one region of a picture, said coding type being one of Intra coding or Inter coding; and
decoding luma and chroma components of the at least one region of a picture according to the coding type and coding tree type.

17. The method of claim 16, wherein a coding type for the at least one region of a picture is derived from the coding tree type, and
wherein the coding type of the at least one region is Intra coding in case the coding tree type is dual, wherein the coding type of the at least one region is Inter coding in case the coding tree type is joint.

18. The method of claim 16, further comprising decoding at least one syntax data element related to a coding type of the at least one region of a picture.

19. An apparatus comprising a memory and one or more processors configured to:
decode at least one syntax data element related to a coding tree type of at least one region of a picture, wherein the coding tree type is one of dual or joint, a dual coding tree type indicating two separate coding syntax structure for luma and chroma components, a joint coding tree type indicating a coding syntax structure commonly used for luma and chroma components, and wherein a region of a picture is one of a tile, a coding tree unit CTU, a rectangular region of the picture wherein a same coding tree type is used for luma and chroma components of the rectangular region;
obtain a coding type of the at least one region of a picture, said coding type being one of Intra coding or Inter coding; and
decode luma and chroma components of the at least one region of a picture according to the coding type and coding tree type.

20. The apparatus of claim 19, wherein a coding type for the at least one region of a picture is derived from the coding tree type, and
wherein the coding type of the at least one region is Intra coding in case the coding tree type is dual, wherein the coding type of the at least one region is Inter coding in case the coding tree type is joint.

21. The apparatus of claim 19, wherein the one or more processors are further configured to decode at least one syntax data element related to a coding type of the at least one region of a picture.

22. A method, comprising:
encoding at least one syntax data element related to a coding tree type of at least one region of a picture, wherein the coding tree type is one of dual or joint, a dual coding tree type indicating two separate coding syntax structure for luma and chroma components, a joint coding tree type indicating a coding syntax structure commonly used for luma and chroma components, and wherein a region of a picture is one of a tile, a coding tree unit CTU, a rectangular region of the picture wherein a same coding tree type is used for luma and chroma components of the rectangular region;
obtaining a coding type of the at least one region of a picture, said coding type being one of is one of Intra coding or Inter coding; and
encoding luma and chroma components of the at least one region of a picture according to the coding type and coding tree type.

23. The method of claim 22, wherein a coding type for the at least one region of a picture is derived from the coding tree type, and
wherein the coding type of the at least one region is Intra coding in case the coding tree type is dual, wherein the coding type of the at least one region is Inter coding in case the coding tree type is joint.

24. The method of claim 22, further comprising encoding at least one syntax data element related to a coding type of the at least one region of a picture.

25. An apparatus comprising a memory and one or more processors configured to:
encode at least one syntax data element related to a coding tree type of at least one region of a picture, wherein the coding tree type is one of dual or joint, a dual coding tree type indicating two separate coding syntax structure for luma and chroma components, a joint coding tree type indicating a coding syntax structure commonly used for luma and chroma components, and wherein a region of a picture is one of a tile, a coding tree unit CTU, a rectangular region of the picture wherein a same coding tree type is used for luma and chroma components of the rectangular region;
obtain a coding type of the at least one region of a picture, said coding type being one of is one of Intra coding or Inter coding; and
encode luma and chroma components of the at least one region of a picture according to the coding type and coding tree type.

26. The apparatus of claim 25, wherein a coding type for the at least one region of a picture is derived from the coding tree type, and
wherein the coding type of the at least one region is Intra coding in case the coding tree type is dual, wherein the coding type of the at least one region is Inter coding in case the coding tree type is joint.

27. The apparatus of claim 25, wherein the one or more processors are further configured to encode at least one syntax data element related to a coding type of the at least one region of a picture.

28. A non-transitory program storage device having encoded data representative of a region in a picture of a video, the encoded data comprising at least one encoded syntax data element related to a coding tree type of the at least one region of a picture, wherein the coding tree type is one of dual or joint, a dual coding tree type indicating two separate coding syntax structure for luma and chroma components, a joint coding tree type indicating a coding syntax structure commonly used for luma and chroma components, and wherein a region of a picture is one of a tile, a coding tree unit CTU, a rectangular region of the picture wherein a same coding tree type is used for luma and chroma components of the rectangular region.

29. A non-transitory computer-readable storage medium storing a computer program product comprising program code instructions for implementing the decoding method according to claim 16, when said program is executed on a computer or a processor.

30. A non-transitory computer-readable storage medium storing a computer program product comprising program code instructions for implementing the encoding method according to claim 22, when said program is executed on a computer or a processor.
